(19) United States
(12) Patent Application Publication
(10) Pub. No.: US 2004/0049902 A1
(43) Pub. Date: Mar. 18, 2004

(54) Machine tool and method for machining

(76) Inventor: Allan Hagstrom, Motala (SE)

Correspondence Address: FASTH LAW OFFICES, 629 E. BOCA RATON ROAD, PHOENIX, AZ, 85022, US

(21) Appl. No.: 10/203,913

(22) PCT Filed: Feb. 12, 2001
(86) PCT No.: PCT/SE01/00276

(30) Foreign Application Priority Data
Feb. 14, 2000 (SE) 0000462-2

(51) Int. Cl. B23Q 39/02

(52) U.S. Cl. 29/26 A

(57) ABSTRACT

The present invention relates to a machine tool comprising a turning head with turning tool (18) and tool holder (26). The object of the invention is to improve and make a tool machine with turning function more flexible. In accordance with the invention the turning tool (18) is pivotably arranged in the tool holder (26). This achieves increased possibility to easily turn a workpiece on an inclined work table, turn a workpiece on both the inside and outside and to allow the turning tool to perform an optionally chosen feeding movement. The invention also relates to a method for machining in which the turning tool is pivoted during the turning process and/or between different turning processes.

### TECHNICAL FIELD

The present invention relates in a first aspect to a machine tool of the type described in the preamble to claim 1. A second aspect of the invention relates to a method for machining a workpiece, of the type described in the preamble to claim 13.

The invention thus relates to the turning function of such a machine tool. The machine may be a simple lathe, but multi-operational machines that perform machining other than turning, such as milling and drilling, also fall within the scope of the invention. The invention is applicable to both simple types of machine tools and advanced numerically controlled machines.

### BACKGROUND ART

Turning operations are conventionally performed as a result of the relative movement arising when the workpiece rotates and the turning tool performs a linear feeding movement. Apart from the feeding movement, therefore, the turning tool is in principle stationary. This entails certain drawbacks for some types of turning operations, as well as limiting the use of turning as a machining method. One example of a situation where drawbacks or limitations of this type may be encountered is when turning a workpiece that is clamped to a tiltable work table. Another example is when a workpiece is to be turned both inside and outside. Yet another case is when the turning process forces the stationary turning tool to assume a direction in which its tip is aimed towards the axis of rotation of the workpiece, thereby causing unfavourable relative directions of the machining forces.

### DESCRIPTION OF THE INVENTION

The object of the present invention is to eliminate the drawbacks and limitations inherent in conventional lathes in the respects mentioned above.

This object has been achieved in accordance with the first aspect of the invention in that a machine tool of the type described in the preamble to claim 1 comprises the specific features defined in the characterizing part of the claim.

Making the turning tool pivotable and providing the lathe with a tiltable table thus achieves increased flexibility during the turning. Furthermore, several operations can be performed with the same set-up of the workpiece and with the same turning tool. A favourable direction for the machining forces and increased precision can also be achieved with the machine tool in accordance with the invention.

In the following the terms X-direction, Y-direction and Z-direction will be used. The Z-direction is the vertical direction of a lathe having a work table with vertical axis of rotation, i.e. the axis of rotation in the normal position. The X-direction is the direction of feed of the turning tool during normal turning, i.e. usually in lateral direction of the machine. Y-direction is thus in the depth direction of the machine.

The machining plane is the plane defined by the axis of rotation of the workpiece and the direction of the turning tool, i.e. the direction in which its tip points. For normal turning, therefore, the machining plane above is defined as the X-Z plane.

If the workpiece is set up on a tiltable work table the turning will no longer occur in the X-Z plane, but instead in the Y-Z plane.

When turning in the X-Z plane the tool is traditionally applied “across the machine”, i.e. with its direction in X-direction. During external turning and with a certain direction of rotation of the workpiece, the tip of the tool shall point in a specific direction, let us assume +X, whereas during internal turning with the same direction of rotation, the tip of the tool must be aimed in −X-direction.

Since the turning tool is pivotable, the same tool can be used for both internal and external turning. Neither need the tool slide be positioned on the opposite side of the axis of rotation. Thus the X-slide need only cover half the diameter. Without the pivoting possibility the tool must be position on the other side of the axis of rotation and this results in an unfavourable alignment of the shearing force for one of the cutting edges since the shearing force component changes direction. For reasons of stability it is generally desired to direct all forces arising in conjunction with cutting machining in towards the machine. The undesired effect obtained when the forces are directed outwards from the machine is avoided by rotating the tool.

Further advantages that can be achieved with a pivotable turning tool are revealed below in the description of preferred embodiments of the machine tool in accordance with the invention.

In accordance with a preferred embodiment of the invention the turning tool is pivotable at least 180°. The advantages achieved with it being pivotable are thus utilised to the full and, as described above, turning can be advantageously performed both internal and externally without exchanging tools.

In accordance with another preferred embodiment of the invention, the turning tool can be rotated while the machine is in operation. During turning the tool must always be placed radially to the workpiece and the tool extension shall point towards the axis of rotation. This is normally achieved by aligning the tool parallel with the X-axis and having its path towards the centre of rotation follow the X-axis. However, in certain cases it may be of interest for the path of the tool towards the axis of rotation to follow a path other than parallel with the X-axis. For instance, for the path of the tool to constitute an interpolated distance with movement in both X- and Y-direction. In this case also, it must be possible to pivot the tool so that its extension constantly points towards the axis of rotation. This can be realised with a turning tool that is continuously pivotable during operation.

In accordance with an advantageous variant of this embodiment control means are arranged to control this rotation. This ensures that the turning tool in the case described above is always directed towards the axis of rotation.

A suitable embodiment in this case is for the control means to comprise software that ensures that the turning tool follows a predetermined pattern of movement. The machine can then be programmed on the basis of the machining data and other stipulations so that the turning tool will automatically always have the correct direction.

If no pivoting movement is required during operation it is important for the position of the turning tool in pivoting direction to be secured.

In accordance with a preferred embodiment of the invention, therefore locking means are provided in the tool holder and arranged to secure the turning tool in an optionally chosen pivoting position. This embodiment permits the greatest possible flexibility as regards the direction in which the turning tool is aimed.

In accordance with an alternatively preferred embodiment the locking means is arranged to secure the turning tool in one of a plurality of predetermined distinct positions. This embodiment admittedly limits the alignment possibilities of the turning tool, but has the advantage that locking can be secured in a simple manner.

In this alternatively preferred embodiment the locking means is suitably of mechanical type.

In accordance with a preferred embodiment the mechanical locking means comprises a toothed coupling having axially directed teeth on the turning tool and axially counter-directed teeth on the tool holder. With such an arrangement locking will be extremely stable.

In accordance with a preferred embodiment the tooth connection is engaged or disengaged by means of connection and disconnection means that displace the turning tool axially. This enables simple, easily controlled operation when setting the pivot position of the turning tool.

The connection and disconnection means suitably comprises a fluid-operated, double-acting piston. The two opposing axial movements for connection and disconnection can in this way be easily achieved, using drive means that is usually easily accessible near the machine tool. This constitutes an additional preferred embodiment of this invention.

In accordance with a preferred embodiment an electric motor is used to rotate the turning tool. This provides a simple, easily operated solution for achieving the pivoting movement of the turning tool in accordance with a certain pattern or for setting the turning tool in a certain position.

The advantageous embodiments of the machine tool in accordance with the invention described above are defined in the sub-claims dependent on claim 1.

In accordance with a second aspect the object of the invention is achieved by means of a method of the type described in the preamble to claim 13 comprising the special features as defined in the characterizing part of the claim. By performing the turning in such a manner advantages are gained equivalent to those gained through the machine tool, which have also been described above.

This method is suitably performed using the machine tool claimed, particularly in accordance with any one of the preferred embodiments. This therefore constitutes a preferred embodiment of the method in accordance with the invention.

In accordance with yet another preferred embodiment of the method in accordance with the invention the turning tool is rotated during the turning process so that its tip is continuously directed towards the axis of rotation of the workpiece. This allows turning to be performed when the path of the tool deviates from the X-axis, without the tool being obliquely directed. The direction of the turning tool is deemed to be the direction for bisection to the tip of the turning tool.

In accordance with still another preferred embodiment of the method in accordance with the invention, it is applied on a workpiece having inside and outside, both of which shall be turned. The turning tool is pivoted 180° between turning the inside and turning the outside. Turning such a workpiece in this way makes exchanging turning tools or positioning the turning tool on the opposite side of the workpiece unnecessary, thus contributing considerable advantages as described above in conjunction with a preferred embodiment of the machine tool in accordance with the invention.

The advantageous embodiments of the method in accordance with the invention described above are defined in the sub-claims dependent on claim 13.

The invention will be described more fully in the following detailed description of advantageous embodiments thereof with reference to the accompanying drawings.

### BRIEF DESCRIPTION OF THE DRAWINGS

FIG. 1 is a view in perspective of a first type of machine tool.

FIG. 2 is a vertical section through a second type of machine tool.

FIG. 3 is a basic diagram of a turning head in a machine in accordance with a first embodiment of the invention.

FIG. 4 is a basic diagram of a turning head in a machine in accordance with a second embodiment of the invention.

FIG. 5 is a section along the line V-V in FIG. 4.

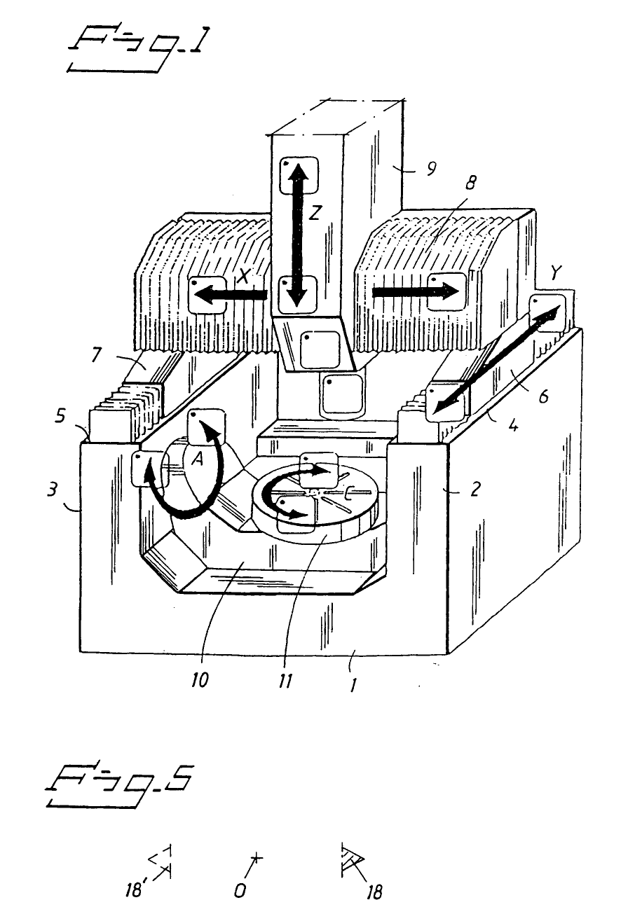

In a view in perspective, seen from the front, FIG. 1 shows a machine tool of a type that may be suitable for construction in accordance with the invention. The base of the machine consists of a base frame 1 with an upwardly directed wall 2, 3 on each side of the machine. The side walls support a portal in which the turning tool is suspended. Atop each side wall 2, 3 is a track 4, 5 along which a slide 6, 7 is movable. The slides 6, 7 for a part of the portal and are connected by a crossbeam 8. Displacement of the slides allows the crossbeam to move both ways in Y-direction, i.e. inwards and outwards in relation to the machine, as indicated in the drawing.

A vertically directed tool-carrying unit 9 is applied on the crossbeam 8. This unit 9 is arranged to be laterally displaceable both ways on the crossbeam 8, this direction of movement being defined as X-direction. The tool holder (not shown in the figure) is secured to the tool-carrying unit 9 and is arranged to be displaced vertically both ways in the tool-carrying unit 9, i.e. in Z-direction.

The tool holder is thus movable in three orthogonal directions: X-, Y- and Z-directions. The movement of the tool holder in these three directions is generally pre-programmed and is effected by electric motors.

A cradle 10 is suspended between the two side walls 2, 3. The cradle 10 is pivotably connected to the side walls 2, 3 and can thus be pivoted to an optional position about an axis in the X-direction. The pivoting possibility is illustrated by the arrow A in the figure. On the cradle 10 is the work table 11, on which the workpiece is secured. The work table 11 is rotatably journalled in the cradle 10 about an axis of rotation that is directed radially in relation to the pivoting direction A of the cradle The axis of rotation is thus vertical, i.e. in the Z-direction, when the cradle 10 is in its horizontal, neutral position as shown in the figure. The rotary movement of the work table 11 is illustrated in the figure by the arrow C.

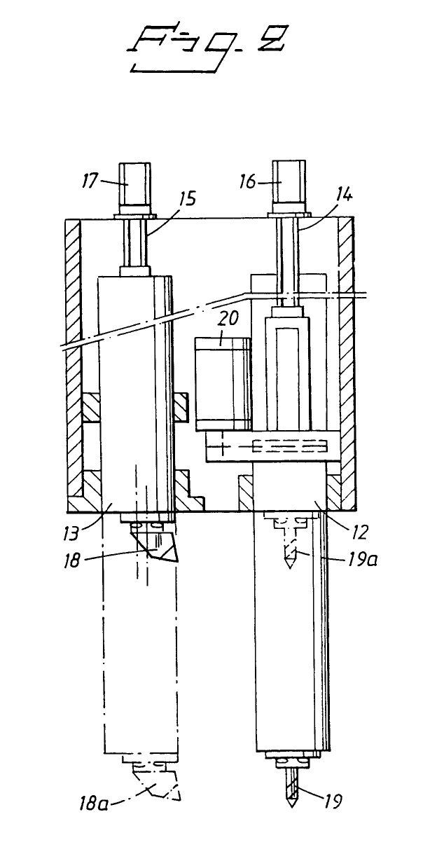

The machine shown in FIG. 1 is intended only for turning. However, a combination machine may also be constructed in accordance with the invention. A combination machine is shown in FIG. 2 which, in a vertical section through a part thereof, shows a milling spindle 12 with drive motor 20 and a tool holder 13 for a turning tool. It is clear from the figure that both the milling spindle 12 and the tool holder 13 are vertically displaceable along guides 14, 15, respectively, with the aid of motors 16, 17, respectively. The figure shows the turning tool 18 in its highest position and the milling cutter 19 in its lowest position. The opposite positions are indicated by 18a and 19a, respectively. The stroke length between the end positions may be in the order of 500 mm.

The above descriptions referring to FIGS. 1 and 2 constitute well-known technology. FIG. 3 now shows a turning head of the particular type to which the invention relates.

The turning tool 18 is provided with a toothed rim 21 and is journalled in the tool holder 26, symbolised by the bearing 27 in the figure. The turning tool 18 is naturally also axially journalled in suitable manner in the tool holder, so that the tool is axially fixed in relation to the tool holder. The toothed rim 21 is in engagement with a toothed wheel 22, driven by an electric motor 23. The electric motor is controlled from a program unit 25 by a control means 24, in accordance with a predetermined program. Thus the turning tool 18 can be caused by the controlled motor 23, via the toothed gear drive 21, 22 to effect a rotary movement about the axis 0 during the turning process in accordance with a predetermined movement pattern.

The device shown in FIG. 3 can also be used without the turning tool being rotated during the actual turning process, but where the tool shall be rotated to a specific position prior to the turning operation. The motor is then activated to rotate the turning tool to the desired position, after which it is locked in this position and turning can be commenced. Locking can be achieved by means of the toothed gear drive 21, 22 which thus acts as locking member. An additional external locking member may possibly also be arranged for increased safety.

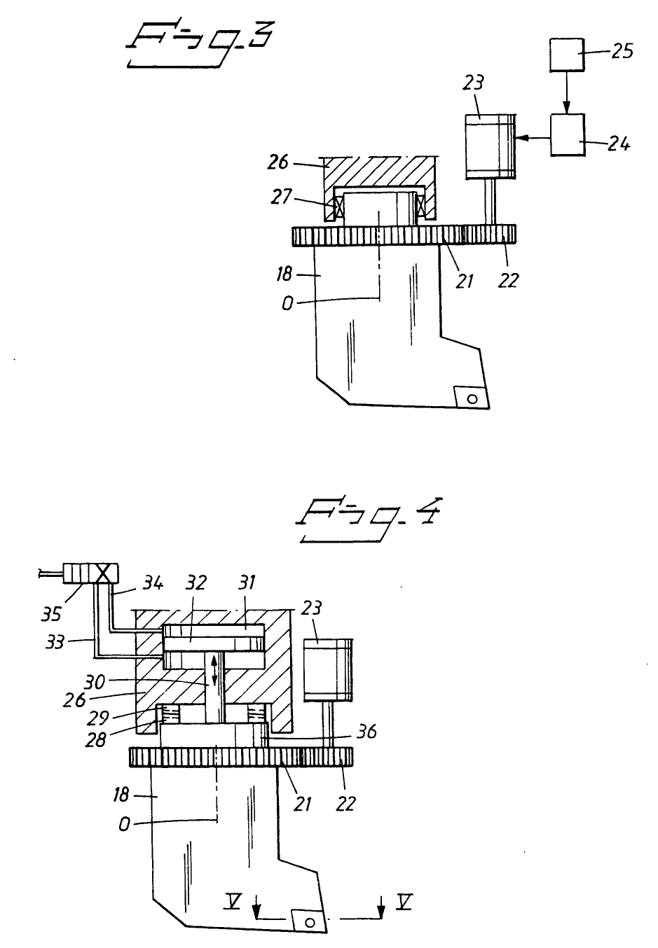

FIG. 4 shows an alternative embodiment in which the position of the turning tool can be set prior to turning, but pivoting cannot be performed during the actual turning. As in the embodiment shown in FIG. 3, the turning tool 18 is provided with a toothed rim 21 in engagement with a toothed wheel 22 rotated by an electric motor. The turning tool 18 has an attachment part 36 provided with upwardly directed axial teeth 29. The teeth 28 and 29 are arranged on respective rings situated opposite each other. The turning tool is connected via a piston rod 30 to a piston 32 arranged to be sealingly displaced in a cylinder 31. On each side of the piston the cylinder 31 is provided with a hydraulic pipe 33, 34, connected to a two-way valve 35.

The position of the turning tool 18 is set by the toothed rings 28, 29 being disengaged from each other through the cylinder 31 being pressurised on the upper side on the piston 32. The piston 32 is thus pressed down and forces the turning tool 18 down so that the teeth 28 on the turning tool are released from engagement with the teeth 29 on the tool holder 26. The turning tool 18 can now be rotated about the axis 0, this being achieved by the electric motor 23 being started and, via the toothed gear drive 22, 21, rotating the turning tool 18 to the desired position. When this has been achieved, the motor 23 is stopped, after which the valve 35 switches the hydraulic connections so that the cylinder 31 is pressurized on the lower side of the piston 32. The piston 32 is then pressed upwards and the piston rod 30 pulls the turning tool 18 upwards so that its teeth engage with the teeth 29 of the tool holder. Engagement of the teeth 28, 29 causes the turning tool 18 to be firmly locked in the set position and turning can commence.

FIG. 5, which is a section along the line V-V in FIG. 4, illustrates how the turning tool can be rotated about an axis of rotation 0 from a first position 18 marked with unbroken lines, to a second position 18 marked with broken lines. The angle between the two positions is here 180°. This is an application in which the outside of a workpiece is to be turned in one position and the inside of the same workpiece is to be turned in the other position.

1. A machine tool comprising a turning head with turning tool (18) and tool holder (26), which turning tool (18) is pivotably arranged in the tool holder (26), characterized in that the turning tool (18) is arranged to allow turning in a first angular position and in a plurality of further angular positions.

2. A machine tool as claimed in claim 1, characterized in that the turning tool (18) is pivotable at least 180°.

3. A machine tool as claimed in claim 1 or claim 2, characterized in that the turning tool (18) is arranged to be able to be pivoted continuously during operation.

4. A machine tool as claimed in claim 3, characterized in that the machine tool is provided with control means (24) arranged to control pivoting of the turning tool.

5. A machine tool as claimed in claim 4, characterized in that the control means (24) comprises software (25) arranged to control pivoting of the turning tool (18) in accordance with a predetermined pattern of movement.

6. A machine tool as claimed in claim 1 or claim 2, characterized in that the tool holder (26) comprises locking means (21, 22) arranged to lock the turning tool (18) in an optionally chosen position.

7. A machine tool as claimed in claim 1 or claim 2, characterized in that the tool holder (26) comprises locking means (28, 29) arranged to lock the turning tool (18) in one of a plurality of predetermined distinct positions.

8. A machine tool as claimed in claim 7, characterized in that the locking means (28, 29) is mechanical.

9. A machine tool as claimed in claim 8, characterized in that the locking means comprises a toothed coupling (28, 29) having axially directed teeth (29) on the tool holder (26) for co-operation with axially counter-directed teeth (28) on the turning tool (18).

10. A machine tool as claimed in claim 9, characterized in that the locking means comprises connection and disconnection members (32) to cause the teeth (28) of the turning tool (18) to engage or disengage with the teeth (29) of the tool holder (26), the connection and disconnection member (32) being arranged to be able to displace the turning tool (18) axially in relation to the tool holder (26).

11. A machine tool as claimed in claim 10, characterized in that the connection and disconnection member comprises a fluid-operated, double-acting piston (32).

12. A machine tool as claimed in any one of claims 1-11, characterized in that the machine comprises an electric motor (23) arranged to be able to pivot the turning tool (18).

13. A machine tool as claimed in any of claims 1-12, characterized in that the machine comprises a tiltable work table (11).

14. A method for machining a workpiece by means of a turning tool, in which the turning tool is pivoted during the turning process and/or between different turning processes, characterized in that turning is made in a first angular position an in a plurality of further angular positions.

15. A method as claimed in claim 14, characterized in that the turning is performed by a machine tool of the type claimed in any one of claims 1-13.

16. A method as claimed in either of claims 14 or 15, characterized in that the turning tool is pivoted during the turning process so that its tip is continuously directed towards the axis of rotation of the workpiece.
